(19) United States
(12) Patent Application Publication
(10) Pub. No.: US 2013/0117031 A1
(43) Pub. Date: May 9, 2013

(54) AUDIO DATA ENCODING METHOD AND DEVICE

(71) Applicant: Zhan Chen, Guangdong (CN)

(72) Inventor: Zhan Chen, Guangdong (CN)

(73) Assignee: ACTIONS SEMICONDUCTOR CO., LTD., Guangdong (CN)

(21) Appl. No.: 13/809,474

(22) PCT Filed: Jul. 12, 2011
(86) PCT No.: PCT/CN11/77067

§ 371 Date: Jan. 10, 2013

(30) Foreign Application Priority Data
Jul. 13, 2010 (CN) 201010229592.6

(51) Int. Cl. G10L 21/00

(52) U.S. Cl. CPC G10L 21/00
USPC 704/500

(57) ABSTRACT

Provided is an audio data encoding method and device for use in Ogg/Vorbis encoding in portable multimedia players. The method comprises: receiving audio data requiring encoding (300); performing MDCT to the audio data (310); calculating the masking curve on the basis of the MDCT results (320); calculating and generating the base curve on the basis of the masking curve by means of the piecewise linear method (330); calculating and generating the spectral residual on the basis of the masking curve and the base curve (340); performing channel coupling to the spectral residual (350); performing vector quantization calculations on the post-channel coupling results (360); encoding, according to an assigned sampling rate and a bit rate, the data obtained by means of vector quantization calculation, and then obtaining encoded audio data (370). The method substitutes the tone-masking curve and noise-masking curve with a single masking curve, thereby reducing the amount of encoding calculations, and uses an assigned sampling rate and bit rate to encode post-vector quantization data, thereby reducing the amount of program space the encoding occupies. The method reduces the complexity of Ogg/Vorbis encoding calculations, thereby making possible Ogg/Vorbis encoding in a portable device.

This application is a US National Stage of International Application No. PCT/CN2011/077067, filed Jul. 12, 2011, designating the United States, and claiming the benefit of Chinese Patent Application No. 201010229592.6 filed with the Chinese Patent Office on Jul. 13, 2010 and entitled “Method and apparatus for encoding audio data”, both of which are hereby incorporated by reference in their entireties.

### FIELD

The present invention relates to the field of multimedia and particularly to a method and apparatus for encoding audio data.

### BACKGROUND

The Ogg/Vorbis are general perceptual audio encoders developed by the U.S. organization Xiph.org. The Vorbis is a dedicated audio encoding format developed by the Xiph.org, and the Ogg is a multimedia outer encoding format and can contain either a digital audio (Vorbis) or a digital video (Tarkin). As compared with MP3 and other encoding algorithms, the encoding algorithms Ogg/Vorbis are characterized primarily in significant encoding flexibility. A lossy audio compression algorithm adopted for the Ogg/Vorbis is comparable to the existing audio algorithms MPEG (Moving Picture Expert Group/Motion Picture Expert Group)-2, MPEG-4, etc. at a high quality (high bit rate) level (CD or DAT stereo with 16/24-bit quantization); and the Ogg/Vorbis encoders can compress a CD or DAT high-quality stereo signal to a bit rate below 48 Kbps without re-sampling to a low sampling rate. It supports a CD audio or PCM data of more than 16 bits at a sampling rate 8-192 kHz and a Variable Bit Ratio (VBR) mode of 30-190 Kbps/channel and is provided with real-time adjusting of a compression ratio to enable a user to change a compression ratio immediately during compression of a file without interrupting the operation. The Ogg/Vorbis support a mono, a stereo, 4 channels and 5.1 channels and can support up to 255 separate channels.

An encoding process of the Ogg/Vorbis is also to window a time domain signal gradually per frame, where frames are divided into long and short frames, and a general flow of encoding each frame of signal is as illustrated in FIG. 1, particularly as follows:

The encoder firstly makes an MDCT (Modified Discrete Cosine Transform) analysis of an input audio PCM signal while making an FFT analysis of the input audio PCM (Pulse Code Modulation) signal, and then two sets of coefficients resulting from the MDCT analysis and the FFT analysis are input to a psychological acoustic model unit, where a noise mask characteristic is calculated with the MDCT coefficients and a tone mask characteristic is calculated with the FFT coefficients, and an overall mask curve is constituted jointly of calculation results of both. Then a linear predictive analysis is made on spectral coefficients according to the MDCT coefficients and the resulting overall mask curve, and then a spectral envelop, i.e., a floor curve, is calculated from a Line Spectral Pair (LSP) which is transformed from Linear Predictive Coefficients (LPC); or the floor curve is obtained through linear segmented approximation. Next the spectral envelop is removed from the MDCT coefficients to obtain a whitened residual spectrum to thereby lower a quantization error due to a significantly narrowed dynamic range of the residual spectrum. Thereafter redundancy of the resulting residual spectrum is further lowered through channel coupling which is primarily intended to map left and right channel data from rectangular coordinates to square polar coordinates; and finally a vector-quantization process is performed by encoding the floor curve and the residual spectral information subjected to channel coupling using a codebook corresponding to a sampling rate and a bit rate of that frame of data (various codebooks may be pre-stored in the system to correspond to different sampling rates and bit rates). In the end, the various whitened information data including the vector-quantized data is assembled in a Vorbis defined packet format into a Vorbis compressed code stream.

As can be apparent, the Ogg/Vorbis encoding operation flow is highly complex in terms of both calculation and a space, therefore an existing portable multimedia player with a poor execution capability of a processing chip can not support Ogg/Vorbis encoding.

### SUMMARY

Embodiments of the invention provide a method and apparatus for encoding audio data so as to perform Ogg/Vorbis encoding in a portable multimedia player.

Specific technical solutions according to the embodiments of the invention are as follows:

A method for encoding audio data includes:

receiving audio data to be encoded;

performing Modified Discrete Cosine Transform, MDCT on the audio data;

calculating a mask curve from a result of the MDCT;

calculating a floor curve from the mask curve through linear segmentation;

calculating a spectral residual from the mask curve and the floor curve;

channel-coupling the spectral residual;

vector-quantizing a result of the channel-coupling; and

encoding the vector-quantized data at a specified sampling rate and bit rate into the encoded audio data.

An audio encoding apparatus includes:

a discrete cosine transform unit configured to receive audio data to be encoded and to perform Modified Discrete Cosine Transform, i.e., MDCT, on the audio data;

a first calculation unit configured to calculate a mask curve from a result of the MDCT;

a second calculation unit configured to calculate a floor curve from the mask curve through linear segmentation;

a third calculation unit configured to calculate a spectral residual from the mask curve and the floor curve;

a coupling unit configured to channel-couple the spectral residual;

a vector-quantization unit configured to vector-quantize a result of the channel-coupling; and

an encoding unit configured to encode the vector-quantized data at a specified sampling rate and bit rate into the encoded audio data.

An audio processing device includes the foregoing audio encoding apparatus.

In summary, a newly designed mask curve is adopted in the embodiments of the invention to replace the tone mask curve and the noise mask curve calculated in the prior art to thereby reduce effectively the amount of calculation for Ogg/Vorbis encoding; and on the other hand, vector-quantized data is encoded at a specified sampling rate and bit rate to thereby reduce effectively a procedure space occupied for Ogg/Vorbis encoding. Thus the calculation and spatial complexity of Ogg/Vorbis encoding can be lowered to thereby enable Ogg/Vorbis encoding in a portable multimedia playing device and further to extend encoding formats supported by the portable multimedia playing device and improve the encoding function thereof, thus enabling the portable multimedia playing device to record audio data with a higher quality.

### BRIEF DESCRIPTION OF THE DRAWINGS

FIG. 1 is a principle diagram of Ogg/Vorbis encoding in the prior art;

FIG. 2 is a functional structural diagram of an audio encoding apparatus in an embodiment of the invention;

FIG. 3A is a flow chart of Ogg/Vorbis encoding in an embodiment of the invention;

FIG. 3B is a schematic diagram of coupled square polar coordinates in an embodiment of the invention;

FIG. 4A is a schematic effect diagram of Ogg/Vorbis encoding on a song 1 in the prior art;

FIG. 4B is a schematic effect diagram of Ogg/Vorbis encoding on the song 1 in an embodiment of the invention;

FIG. 5A is a schematic effect diagram of Ogg/Vorbis encoding on a song 2 in the prior art;

FIG. 5B is a schematic effect diagram of Ogg/Vorbis encoding on the song 2 in an embodiment of the invention;

FIG. 6A is a schematic effect diagram of Ogg/Vorbis encoding on a song 3 in the prior art;

FIG. 6B is a schematic effect diagram of Ogg/Vorbis encoding on the song 3 in an embodiment of the invention;

FIG. 7A is a schematic effect diagram of Ogg/Vorbis encoding on a song 4 in the prior art;

FIG. 7B is a schematic effect diagram of Ogg/Vorbis encoding on the song 4 in an embodiment of the invention; and

FIG. 8 is a functional structural diagram of an audio processing device including the audio encoding apparatus in an embodiment of the invention.

### DETAILED DESCRIPTION OF THE EMBODIMENTS

In view of the considerable difficulty in performing full Ogg/Vorbis encoding in a portable multimedia player, the Ogg/Vorbis encoding flow is optimized as appropriate in embodiments of the invention in order to lower the complexity of performing Ogg/Vorbis encoding, particularly as follows: audio data to be encoded is received, Modified Discrete Cosine Transform, i.e., MDCT, is performed on the audio data, and then a mask curve is calculated from a result of the MDCT, a floor curve is calculated from the mask curve through linear segmentation, and a spectral residual is calculated from the mask curve and the floor curve and then is channel-coupled, and a result of the channel coupling is vector-quantized, and finally the vector-quantized data is encoded at a specified sampling rate and bit rate into the encoded audio data.

Numerous data experiments showed the Ogg/Vorbis encoding procedure can be optimized in the following several aspects to save a considerable amount of calculation and procedure space without significantly lowering the quality of an encoded Ogg/Vorbis audio signal, which is substantially the same as a result of encoding in the original standard OGG procedure.

1. A psychological acoustic model can be optimized by merging a noise mask curve and a tone mask curve into one to thereby save a considerable amount of calculation.

For example, a corresponding mask compensation value can be determined among a plurality of pre-stored mask compensation tables (experimentally obtained in advance) according to a sampling rate and a bit rate in a specific implementation. A mask compensation table is set under a theoretical basis of sensitivity of people to a voice frequency, where human ears are sensitive to voice at a low frequency and insensitive to voice at a high frequency, and thus there is incremented compensation at a low frequency and decremented compensation at a high frequency, so that values of the mask compensation table decrement gradually from low to high frequencies. A mask curve is compensated with the table so that the one mask curve can attain a similar effect to that of two original curves, i.e., a noise mask curve and a tone mask curve.

2. Encoding can be performed at a specified sampling rate and bit rate to thereby save a considerable amount of calculation and procedure space.

For example, the same codebook can be adopted for encoding for different bit rates at the same sampling rate in a specific implementation to reduce the amount of calculation for the procedure and also save a memory space.

A codebook is one of crucial technologies for vector-quantization and typically recorded in the form of a table, and data retrieved from the codebook is a codeword for compression of data.

In other words, in the invention, only one codebook corresponding to a specific sampling rate is stored and the same codebook is adopted for encoding during vector-quantization. As an alternative, only a few codebooks may be stored, and the closest one of them can be selected for encoding or selected and then modified as necessary for encoding during vector-quantization.

Preferred embodiments of the invention will be detailed below with reference to the drawings.

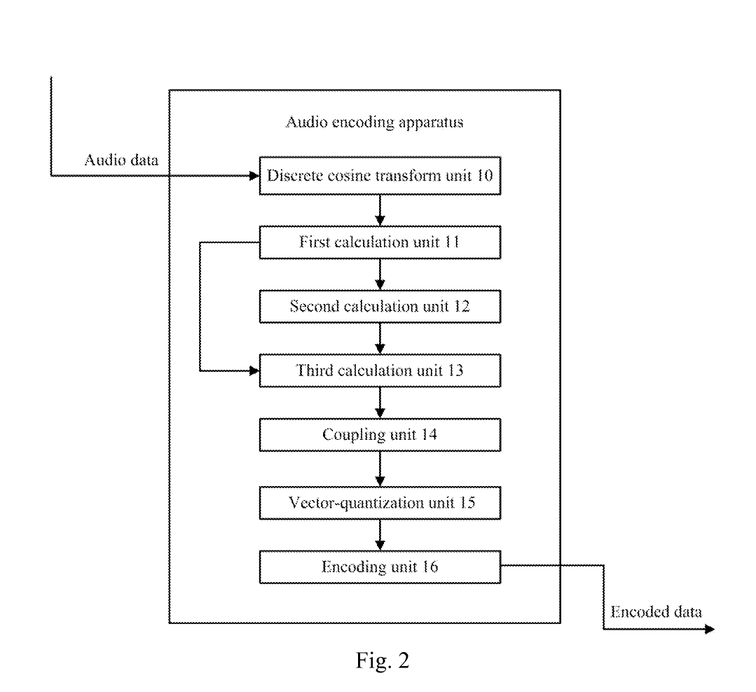

Referring to FIG. 2, an audio encoding apparatus for Ogg/Vorbis encoding in an embodiment of the invention includes a discrete cosine transform unit 10, a first calculation unit 11, a second calculation unit 12, a third calculation unit 13, a coupling unit 14, a vector-quantization unit 15 and an encoding unit 16, where:

The discrete cosine transform unit 10 is configured to receive audio data to be encoded and to perform Modified Discrete Cosine Transform, i.e., MDCT, on the audio data;

The first calculation unit 11 is configured to calculate a mask curve from a result of the MDCT;

The second calculation unit 12 is configured to calculate a floor curve from the mask curve through linear segmentation;

The third calculation unit 13 is configured to calculate a spectral residual from the mask curve and the floor curve;

The coupling unit 14 is configured to channel-couple the spectral residual;

The vector-quantization unit 15 is configured to vector-quantize a result of the channel-coupling; and

The encoding unit 16 is configured to encode the vector-quantized data at a specified sampling rate and bit rate into the encoded audio data.

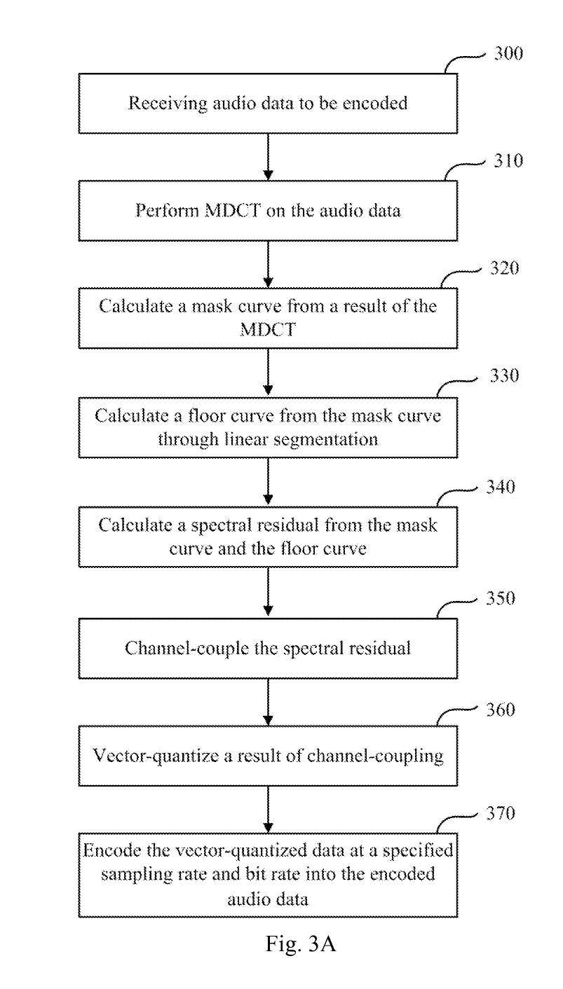

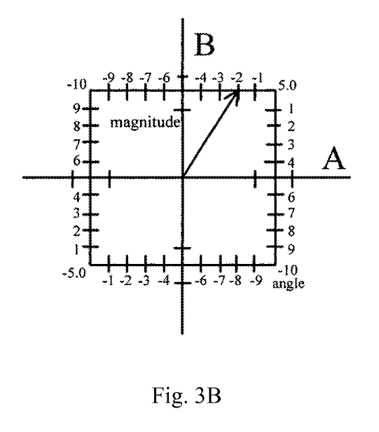

Under the foregoing principle, a detailed flow of Ogg/Vorbis encoding in an embodiment of the invention is as follows with reference to FIG. 3:

Operation 300: Audio data to be encoded is received;

Operation 310: MDCT is performed on the audio data.

In the present embodiment, Modified Discrete Cosine Transform (MDCT) with an overlap of 50% is preferably used as transform means in the time and frequency domains, particularly as follows: the product of a value in the time domain, a window value and a cosine coefficient of each sampling point in the audio data is calculated, and then the respective resulting products are summed up to thereby obtain the MDCT-transformed data in the frequency domain.

For example, MDCT can be performed in the following formula:

[symbol]

,

where,

Where n and k represent indexes of sampling points respectively, X[k] represents a coefficient value in the frequency domain of the sampling point indexed with k, x[n] represents a coefficient value in the time domain of the sampling point indexed with n, h[n] represents a window value of the sampling point indexed with n,

$$cos [ \frac{2 π}{N} ( k + \frac{1}{2} ) ( n + {n}_{0} ) ]$$

is a preset cosine coefficient, π is the circumference ratio, n₀ is a preset constant which is typically set to

$$\frac{\frac{N}{2} + 1}{2} ,$$

and N represents the length of a frame.

Operation 320: A mask curve is calculated from a result of the MDCT.

In the present embodiment, the mask curve can be calculated preferably as follows: the result of the MDCT is multiplied by a first linear regression coefficient, and then a second linear regression coefficient and a preset mask compensation value are added thereto.

For example, the mask curve can be calculated in the following formula:

y=a+bx+c(x),

Where a and b represent preset linear regression coefficients respectively, and c(x) is a preset mask compensation value and can be retrieved from a mask compensation table, and the value of x is X[k] obtained in the operation 310; and With the foregoing formula, a corresponding approximate smooth curve can be obtained from the coefficient values in the frequency field X[k] resulting from MDCT through a linear regression analysis, that is, the final mask curve can be obtained from the smooth curve and the mask compensation values in the foregoing formula.

Furthermore values of a and b can be set as follows:

[symbol]

,

D represents a preset temporary variable, Xᵢ represents a subscript of a spectral line point indexed with i, yᵢ represents energy of the spectral line point indexed with i, N represents the length of a frame, and i can be equal to K when the value of x is X[k].

Human ears are insensitive to a high frequency, so a preset low frequency compensation value can be incremented while decrementing a high frequency compensation value in the mask compensation table in the present embodiment so as to lower the amount of calculation for compensation, that is, the compensation values decrement gradually from low to high frequencies. Specifically:

static int _psy_suppress[11]
=
{
−20,−24,−24,−24,−24,−30,−40,−40,−45,−45,−45,
};

Operation 330: A floor curve is calculated from the mask curve through linear segmentation.

Specific operational steps are as follows:

For example, an envelope of a spectral function is approximated linearly with 11 points (10 broken lines) on a short block and linearly with 33 points on a long block, for both of which exactly the same algorithm applies. The following detailed description will be given taking a short block in a floor-1 algorithm as an example.

Assumed the frequency axis is divided into a set of data [0,1,2,4,7,13,20,30,44,62,128].

1) Magnitude values of the two endpoints 0 and 128 are calculated to represent the entire spectrum;

2) This line segment is divided at the point 13 into two line segments, magnitude values of the three points are calculated respectively, and an envelope of the spectrum is represented approximately by the two line segments;

3) This is repeated by segmenting the line segments in the order of 13, 2, 4, 1, 44, 30, 62, 20 respectively, and

Finally 10 segments of broken lines are obtained to represent entire envelope of the spectrum;

4) The values of two endpoints are represented by absolute values, and the intermediate values are represented differentially through prediction.

5) The 11 points are interpolated linearly into a 128-point floor curve.

Operation 340: A spectral residual is calculated from the mask curve and the floor curve.

They can be converted in the formula of FLOOR1_fromdB_INV_LOOKUP [256]: residue[i]=mdct*FLOOR1_fromdB_INV_LOOKUP[codedflr],

Where mdct represents a logarithmic value of a spectral coefficient resulting from MDCT, codedflr represents a value of the floor curve, residue represents a value of the spectral residual, and FLOOR1_fromdB_INV_LOOKUP[represents a table for converting the floor curve into DB values.

Operation 350: The spectral residual is channel-coupled.

Taking coupling of square polar coordinates as an example:

For Ogg/Vorbis encoding, a unit square is used for one-to-one mapping from rectangular coordinates of left and right channels to square polar coordinates (see FIG. 3B), thus performing an mapping operation through simple addition and subtraction. For example, during decoding, a code stream is parsed for magnitude and angle values, and information of left and right channels can be recovered in the following algorithm (assumed A/B represent left/right or right/left dependent upon an encoder):

```
if(magnitude>0)
    if(angle>0)
  {
      A=magnitude;
      B=magnitude-angle;
    }
  else
  {
        B=magnitude;
        A=magnitude+angle;
  }
  else
  if(angle>0)
  {
        A=magnitude;
        B=magnitude+angle;
  }
  else
  {
      B=magnitude;
      A=magnitude-angle;
      }
    }
```

Operation 360: A result of channel-coupling is vector-quantized.

For example, in specific steps of the vector-quantizing operation, the residual signal is arranged, each channel is divided into blocks which are categorized and then encoded, and finally the data blocks themselves are Vector-Quantization (VQ) encoded. Relative to three different residual patterns, a residual vector can be interleaved and segmented differently. The residual vector to be encoded shall have the same length, and a code structure shall satisfy the following general assumptions:

1) Each channel residual vector is segmented into a plurality of equally long data blocks dependent upon a specific configuration.

2) Each zone of each channel vector has a category index to indicate a VQ codebook to be used for quantization; and category indexes themselves of respective zones constitute a vector. Like a residual vector encoded jointly to improve the efficiency of encoding, a category index vector is also divided into blocks. Respective integer scalar elements in a category block jointly constitute a scalar to represent the category index of the block as illustrated below.

3) A residual vector value can be encoded separately in a separate procedure (a vector with the length of n relates to a procedure), but a more effective codebook design requires that residual vectors corresponding to several procedures are accumulated into a new vector encoded with a plurality of VQ codebooks. A category codeword may be used for encoding only in the first procedure since the same zone has the same category value across the procedures.

Operation 370: The vector-quantized data is encoded at a specified sampling rate and bit rate into the encoded audio data.

The encoded audio data obtained above is desirable audio data in the Ogg/Vorbis encoding format.

A technical effect of Ogg/Vorbis encoding in an embodiment of the invention will be compared and described below against that of Ogg/Vorbis encoding in the prior art:

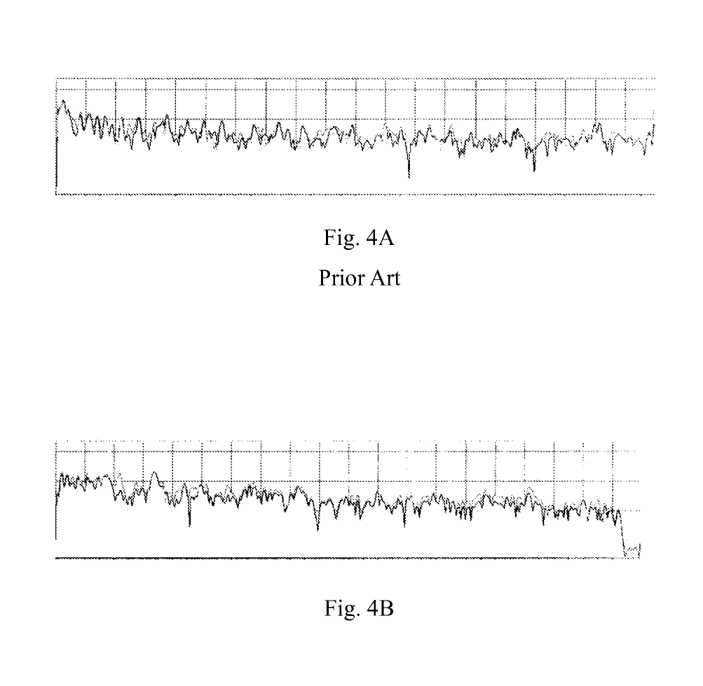

For example, a first song is set at a sampling rate of 8 KHz and a bit rate of 128 kbps, and then a spectral test diagram resulting from Ogg/Vorbis encoding in the prior art is as illustrated in FIG. 4A, and a spectral test diagram resulting from Ogg/Vorbis encoding in the embodiment of the invention is as illustrated in FIG. 4B.

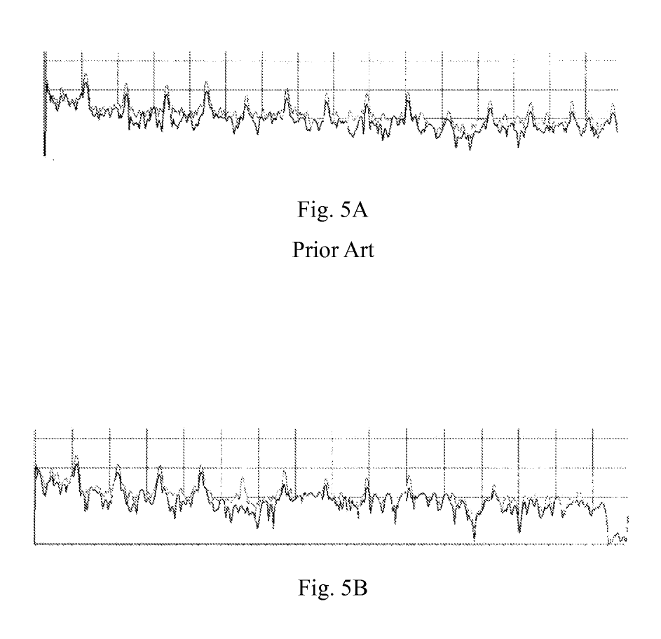

In another example, a second song is set at a sampling rate of 16 KHz and a bit rate of 128 kbps, and then a spectral test diagram resulting from Ogg/Vorbis encoding in the prior art is as illustrated in FIG. 5A, and a spectral test diagram resulting from Ogg/Vorbis encoding in the embodiment of the invention is as illustrated in FIG. 5B.

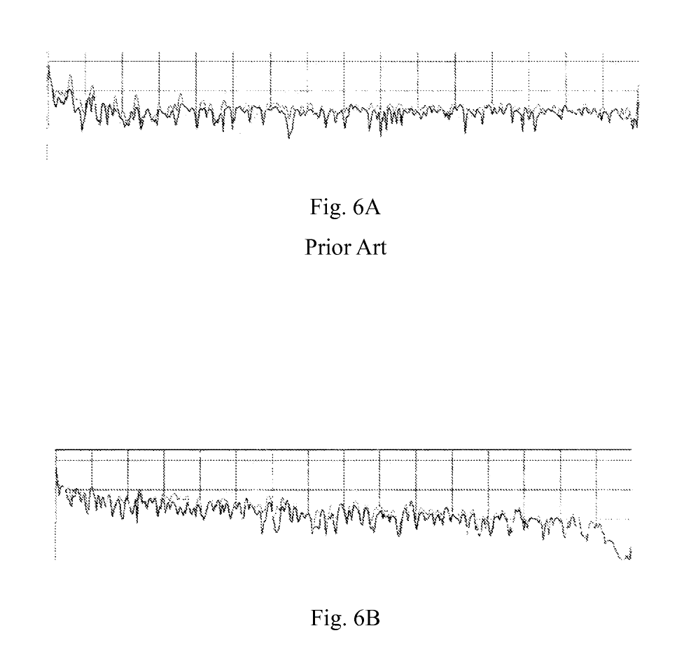

In still another example, a third song is set at a sampling rate of 32 KHz and a bit rate of 128 kbps, and then a spectral test diagram resulting from Ogg/Vorbis encoding in the prior art is as illustrated in FIG. 6A, and a spectral test diagram resulting from Ogg/Vorbis encoding in the embodiment of the invention is as illustrated in FIG. 6B.

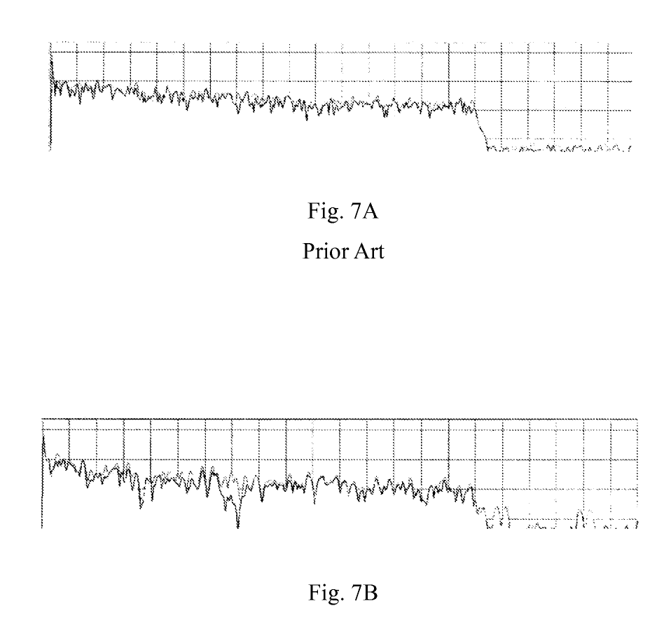

In a further example, a fourth song is set at a sampling rate of 44.1 KHz and a bit rate of 128 kbps, and then a spectral test diagram resulting from Ogg/Vorbis encoding in the prior art is as illustrated in FIG. 7A, and a spectral test diagram resulting from Ogg/Vorbis encoding in the embodiment of the invention is as illustrated in FIG. 7B.

As can be apparent as a result of comparing the foregoing spectral test diagrams, the quality of an audio signal subjected to Ogg/Vorbis encoding in the prior art is substantially consistent with the quality of the audio signal subjected to Ogg/Vorbis encoding in the embodiment of the invention at a low frequency and not significantly attenuated at a high frequency, so it can be said that they have substantially consistent encoding effects and can not be subjectively audibly distinguishable to human ears.

TABLE 1

| | Bit rate | | | | | |
|---|---|---|---|---|---|---|
| | 128 (kbps) | | 256 (kbps) | | 320 (kbps | |
| Sampling rate | Standard OGG | Inventive OGG | Standard OGG | Inventive OGG | Standard OGG | Inventive OGG |
| 44100 | 128 (codebook 0) | 135 (codebook 0) | 256 (codebook 1) | 247 (codebook 0) | 320 (codebook 2) | 318 (codebook 0) |
| 32000 | 120 (codebook 1) | 118 (codebook 1) | 230 (codebook 3) | 232 (codebook 1) | 300 (codebook 2) | 302 (codebook 1) |
| 16000 | 77 (codebook 2) | 87 (codebook 2) | 138 (codebook 3 | 126 (codebook 2) | 155 (codebook 1) | 161 (codebook 2) |
| 8000 | 36 (codebook 3 | 39 (codebook 3) | 54 (codebook 4) | 62 (codebook 3) | 59 (codebook 2) | 76 (codebook 3) |

With the foregoing embodiment, the same codebook is adopted for Ogg/Vorbis encoding for different bit rates at a specific sampling rate in the present embodiment in order to further save the amount of calculation while attaining substantially the same technical effect as Ogg/Vorbis encoding with different codebooks.

Referring to Table 1, for example, the same codebook 0 is adopted for Ogg/Vorbis encoding at a sampling rate of 44100, the same codebook 1 is adopted for Ogg/Vorbis encoding at a sampling rate of 32000, and so on in an embodiment of the invention.

In the prior art, the corresponding codebook 0, codebook 1, codebook 2, codebook 3 or codebook 4 is adopted for Ogg/Vorbis encoding for a different bit rate at the same sampling rate.

Taking the sampling rate of 44100 as an example, a code stream resulting from encoding with the codebook 0 in the prior art has a real bit rate of 128 kbps, and a code stream resulting from encoding with the codebook 0 in the solution of the present embodiment has a real bit rate of 134 kbps, at the sampling rate/bit rate of 44100/128; a code stream resulting from encoding with the codebook 1 in the prior art has a real bit rate of 256 kbps, and a code stream resulting from encoding with the codebook 0 in the solution of the present embodiment has a real bit rate of 247 kbps, at the sampling rate/bit rate of 44100/128; and a code stream resulting from encoding with the codebook 2 in the prior art has a real bit rate of 320 kbps, and a code stream resulting from encoding with the codebook 0 in the solution of the present embodiment has a real bit rate of 318 kbps, at the sampling rate/bit rate of 44100/320.

As can be apparent from the foregoing three instances, the bit ratio of Ogg/Vorbis encoding has a very small change after operating with the same codebook at the same sampling rate and is substantially consistent with the value of the standard (with different codebooks), that is, Ogg/Vorbis encoding with different codebooks attains substantially the same technical effect as that of Ogg/Vorbis encoding with the same codebook, and the difference therebetween is indistinguishable to human ears.

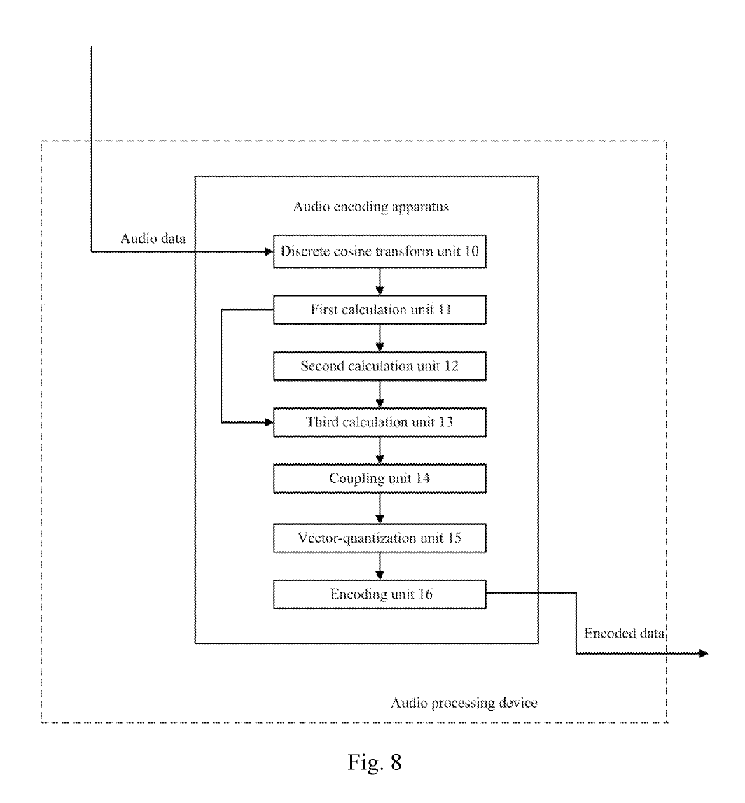

In a practical application, the audio encoding apparatus can be a separate apparatus or arranged internal to an audio processing device (as illustrated in FIG. 8) as one of functional modules of the audio processing device, and a repeated description thereof will be omitted here.

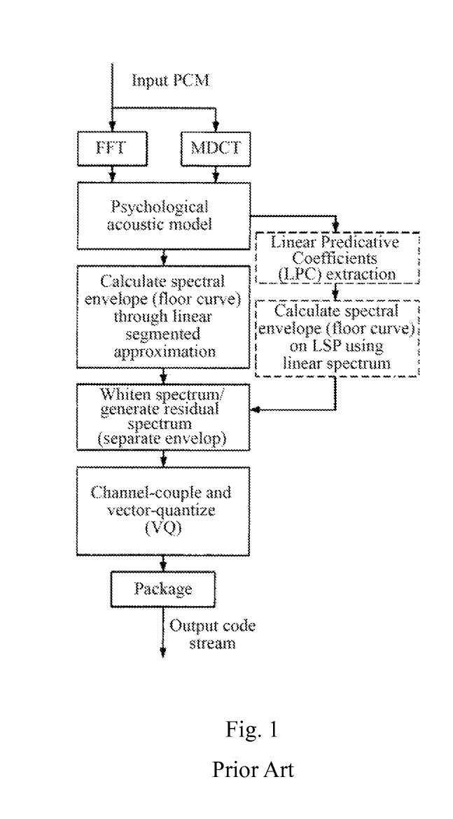

In summary, Ogg/Vorbis encoding in the prior art can not be performed in an existing portable multimedia player in a practical application primarily due to two aspects, i.e., a considerable amount of calculation and a large procedure space as required. In the foregoing embodiment, the Ogg/Vorbis encoding method is simplified as appropriate, and as can be apparent from comparing FIG. 1 with FIG. 3A, a newly designed mask curve is adopted in the operation 300 to the operation 350 to replace a tone mask curve and a noise mask curve calculated in the prior art to thereby reduce effectively the amount of calculation for Ogg/Vorbis encoding; and on the other hand, the vector-quantized data is encoded at a specified sampling rate and bit rate in the operation 360 to the operation 370 to thereby reduce effectively a procedure space occupied for Ogg/Vorbis encoding. Thus the calculation and spatial complexity of Ogg/Vorbis encoding is lowered in the foregoing flow, thereby further making it possible to perform Ogg/Vorbis encoding in the portable multimedia playing device and further to extend encoding formats supported by the portable multimedia playing device and improve the encoding function thereof, thus enabling the portable multimedia playing device to record audio data with a higher quality.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer available storage mediums (including but not limited to a disk memory, a CD-ROM, an optical memory, etc.) in which computer available program codes are contained.

The invention has been described in a flow chart and/or a block diagram of the method, the apparatus (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide operations for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations falling into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method of encoding audio data for Ogg/Vorbis encoding, comprising:
receiving audio data to be encoded;
performing Modified Discrete Cosine Transform, MDCT, on the audio data;
calculating a mask curve from a result of the MDCT;
calculating a floor curve from the mask curve through linear segmentation;
calculating a spectral residual from the mask curve and the floor curve;
channel-coupling the spectral residual;
vector-quantizing a result of the channel-coupling; and
encoding data obtained from the vector-quantizing at a specified sampling rate and bit rate into encoded audio data.

2. The method of claim 1, wherein the MDCT is performed on the audio data by calculating the product of a value in the time domain, a window value and a cosine coefficient of each sampling point in the audio data respectively and then summing up the respective resulting products.

3. The method of claim 1, wherein the mask curve is calculated from the result of the MDCT by multiplying the result of the MDCT by a first linear regression coefficient and then adding a second linear regression coefficient and a preset mask compensation value thereto.

4. The method of claim 1, wherein the data obtained from the vector-quantizing is encoded at the specified sampling rate and bit rate by selecting the same preset codebook for different bit rates at a preset sampling rate to encode the data obtained from the vector-quantizing.

5. An audio encoding apparatus for Ogg/Vorbis encoding, comprising:
a discrete cosine transform unit configured to receive audio data to be encoded and to perform Modified Discrete Cosine Transform, i.e., MDCT, on the audio data;
a first calculation unit configured to calculate a mask curve from a result of the MDCT;
a second calculation unit configured to calculate a floor curve from the mask curve through linear segmentation;
a third calculation unit configured to calculate a spectral residual from the mask curve and the floor curve;
a coupling unit configured to channel-couple the spectral residual;
a vector-quantization unit configured to vector-quantize a result of the channel-coupling; and
an encoding unit configured to encode data obtained from the vector-quantizing at a specified sampling rate and bit rate into encoded audio data.

6. The audio encoding apparatus of claim 5, wherein the discrete cosine transform unit performs the MDCT on the audio data by calculating the product of a value in the time domain, a window value and a cosine coefficient of each sampling point in the audio data respectively and then summing up the respective resulting products.

7. The audio encoding apparatus of claim 5, wherein the first calculation unit calculates the mask curve from the result of the MDCT by multiplying the result of the MDCT by a first linear regression coefficient and then adding a second linear regression coefficient and a preset mask compensation value thereto.

8. The audio encoding apparatus of claim 5, wherein the encoding unit encodes the data obtained from the vector-quantizing at the specified sampling rate and bit rate by selecting the same preset codebook for different bit rates at a preset sampling rate to encode the data obtained from the vector-quantizing.

9. An audio processing device, comprising the audio encoding apparatus according to claim 5.

10. The method of claim 2, wherein the data obtained from the vector-quantizing is encoded at the specified sampling rate and bit rate by selecting the same preset codebook for different bit rates at a preset sampling rate to encode the data obtained from the vector-quantizing.

11. The method of claim 3, wherein the data obtained from the vector-quantizing is encoded at the specified sampling rate and bit rate by selecting the same preset codebook for different bit rates at a preset sampling rate to encode the data obtained from the vector-quantizing.

12. The audio encoding apparatus of claim 6, wherein the encoding unit encodes the data obtained from the vector-quantizing at the specified sampling rate and bit rate by selecting the same preset codebook for different bit rates at a preset sampling rate to encode the data obtained from the vector-quantizing.

13. The audio encoding apparatus of claim 7, wherein the encoding unit encodes the data obtained from the vector-quantizing at the specified sampling rate and bit rate by selecting the same preset codebook for different bit rates at a preset sampling rate to encode the data obtained from the vector-quantizing.
